(19) United States
(12) Patent Application Publication
(10) Pub. No.: US 2023/0408543 A1
(43) Pub. Date: Dec. 21, 2023

(54) SPEED DETECTION DEVICE COMPRISING A KIEL PROBE

(71) Applicant: Christoph Feichtinger, Schildorn (AT)

(72) Inventor: Christoph Feichtinger, Schildorn (AT)

(21) Appl. No.: 17/913,124

(22) PCT Filed: Jan. 11, 2021
(86) PCT No.: PCT/AT2021/060004

§ 371 Date: Sep. 20, 2022

(30) Foreign Application Priority Data
Mar. 31, 2020 (AT) A50263/2020

(51) Int. Cl. G01P 5/165; G01P 13/00; G01P 1/02

(52) U.S. Cl. CPC G01P 5/165; G01P 1/026; G01P 13/0066

(57) ABSTRACT

An apparatus (1) for velocity detection comprises a Kiel probe (2) having a flow velocity probe which is encompassed by a shell element (3) forming a Venturi nozzle. In order to create advantageous measurement conditions, the shell element (3) is designed as a multi-hole dynamic pressure probe having holes (4) in the shell element (3) arranged across the circumference of the shell.

The invention relates to an apparatus for velocity detection, comprising a Kiel probe having a flow velocity probe which is encompassed by a shell element forming a Venturi nozzle.

A Kiel probe is a further development of a Pitot tube, measuring the total pressure in moving flows. The Kiel probe has the advantage over a Pitot tube of having a lower sensitivity in respect of the angle of inflow. The Kiel probe substantially consists of a Venturi nozzle, in the interior of which a Pitot probe is located. The Venturi nozzle deflects the flow in the axial direction, thereby ensuring a more constant inflow to the Pitot probe. In addition to the geometry of the Venturi nozzle, the position of the Pitot probe in the Venturi nozzle, viewed in the axial direction, plays an essential role for the sensitivity in respect of the angle of inflow. One disadvantage is the difficulty of determining the exact wind direction in space for different orientations of the sensor. By using the Kiel probe principle, the wind velocity but not the wind direction can be dependably detected for large angular ranges. Problems can result at angles of inflow which are greater than +−60°.

Venturi nozzles consist of a pipe section having a constriction of the entry cross-section and a widening of the exit cross-section, by two cones directed opposite each other, for example, which are joined at the location of their smallest diameter by a cylinder tube, as applicable.

The inflow direction can be determined by means of a multi-hole probe. In practice, twoor four-finger hole probes, four-finger probes, wedge probes or cylinder probes are used for this purpose.

The risk in determining the inflow direction by means of a pressure method is dependable calibration. The problem with calibration is that the surround flow of the probe head in the event of a directional change is highly transient. In addition, the surround-flow is highly dependent on the turbulent inflow. Local separation effects in the event of oblique inflow can occur depending on the inflow at different locations, as a result of which the calibration must be carried out for all conditions.

Currently available measuring instruments for determining the wind velocity are in most cases very large and not very easy to install overall, particularly in connection with the required analysis unit. Wind measurements on moving objects are primarily carried out today using Pitot, dynamic pressure and multi-hole probes.

In the case of measurements on moving objects, the measurement location and the wind direction therefore change continually, in addition to the time. Depending on the dynamics of the moving object, disruptions to the actual wind measurement result.

Inertial navigation systems are 3D measurement systems having an inertial measurement unit as a central sensor unit comprising a plurality of acceleration and rotation rate sensors. The spatial movement of vehicles or aircraft, for example, is continually determined by integration of the measured accelerations and rotation rates. However, an absolute position, such as by using a GPS, cannot be thereby determined. The primary advantage of inertial navigation systems is that they can be operated without reference; that is, independently of any locating signals. However, a drift in the sensors is unavoidable.

A method and a device for monitoring the fluid-dynamic resistance on an object, such as a bicycle, a land vehicle, a watercraft, an aircraft or a part of a wind turbine, are known from WO 2017 197 524 A1. An arrangement of sensors is additionally provided which detects a power consumption for driving the object, the air speed and direction relative to the motion of the object and a travel velocity of the object.

The following sensor values can also be recorded: temperature, altitude and relative humidity for measuring air density. Sensor values can also indicate angle of inclination and forward acceleration.

A fluid detection apparatus known from US 2018 321272 A1 comprises an outer body having a front side, a rear side and an interior chamber, wherein the outer body contains a fluid inlet arranged on the front side, one or more ventilation openings which are arranged behind the fluid inlet in order to enable the passage of fluid through the fluid detection apparatus and at least one load sensor which is coupled to the inner body in order to measure a fluid resistance force on the inner body.

The invention thus addresses the problem of creating an apparatus for velocity detection of the type described above, which, having compact dimensions, enables proper measurement of wind velocity and wind direction.

The invention solves this problem in that the shell element is designed as a multi-hole dynamic pressure probe having holes in the shell element arranged across the circumference of the shell. Proper measurement of wind velocity and wind direction is enabled by these measures.

The Kiel probe supplies the flow velocity _{S}u_{US}, the x-component of the inflow velocity in the sensor-fixed coordinate system; that is, in the direction of the longitudinal axis of the flow velocity probe. Measurement of the flow velocity in the Kiel probe can be made by a Pitot tube, by ultrasound or via hot-wire measurement. Rectification of the flow by means of the Kiel probe arrangement is crucial for determining the inflow direction independent primary wind velocity _{S}u_{US}. Preferably, the flow velocity can be recorded on the inner shell via a dynamic pressure tube within the Kiel probe and a static pressure transducer for determining a differential pressure, which supplies information with respect to the relative wind velocity.

Problems can result at angles of inflow which are greater than +−60°. For these angular ranges, a query must be stored in analysis software which recognizes these ranges and informs a user of them. The user can then move the sensor to a better position for the angle of inflow.

The shell probe, that is, the shell element designed as a multi-hole dynamic pressure probe having holes in the shell element arranged across the circumference of the shell, enables the measurement of an angle transformation matrix A_{sw} with the two angles of flow, the vertical angle of attack a, and the lateral angle of inflow β, relative to the sensor-fixed coordinate system. The angle transformation matrix is measured via the holes in the shell element arranged across the circumference of the shell, that is, via the pressure measurement points on the shell surface. The individual measurement points for determining the angle of inflow can be arranged on the front inside, front outside, rear outside, rear inside and center outside of the shell element.

An additional problem of conventional anemometers on moving objects today is a calibration of the individual wind components. For example, in classical multi-hole probes, all three wind components are recorded via the same pressure measurement points on the probe head. This makes calibration difficult because the calculation of the absolute velocity from the individual pressure signals is very sensitive to angle changes. The measurement accuracy of the inflow directions is also strongly influenced by this. The apparatus for velocity detection according to the invention solves this problem in that the flow velocity in the longitudinal direction of the sensor and the inflow direction are measured separately. The flow velocity in the longitudinal direction of the sensor is measured by a Kiel probe which is insensitive with respect to the angle of inflow, while the inflow direction itself is measured by a multi-hole dynamic pressure probe having holes in the shell element arranged across the circumference of the shell. All three inflow components can then be calculated from both sensors.

For the best possible measurement results, it is proposed that dynamic pressure sensors are connected to the holes, wherein the holes preferably connect to the dynamic pressure sensors via dynamic pressure channels. Every dynamic pressure channel leads to a separate dynamic pressure sensor in order to be able to rule out mutual influences of the measurements of the individual measurement points.

The holes in the shell element arranged across the circumference of the shell are preferably arranged uniformly distributed about a longitudinal axis of the flow velocity probe in a plane which is perpendicular to the longitudinal axis of the flow velocity probe, such that the flow angle can be cleanly calculated from any differential pressures present at the measurement points of a plane. In addition, it is recommended that the holes allocated to a common plane connect to the dynamic pressure sensors via dynamic pressure channels of equal length in order to be able to ensure identical measurement conditions, in particular response times, for all measurement points allocated to a common plane.

In order to improve the resolution of the flow angle that is to be determined, it can be advantageous if, in the direction of the longitudinal axis of the flow velocity probe, at least two planes that are spaced apart are provided with holes arranged distributed across the circumference of the shell.

By providing an inertial navigation system, preferably embedded in the shell element, and/or a global positioning system, preferably embedded in the shell element, that is, via at least one additional position and location sensor in the multi-sensor, the dynamic interferences of the object motion can be self-measured and correspondingly corrected. In addition, the position and the velocity of the apparatus in space can be determined. The absolute wind velocity ₛv_{w} can be calculated from the inflow velocity ₛvᵤₛ via the additional information of the three-dimensional apparatus velocity ₛvₛ in space.

_{S}v_{W}=_{S}v_{US}−_{S}v_{S}

In order to improve measurement accuracy, a temperature (° C.) and/or relative humidity sensor (rF) can be embedded in the shell element.

In addition, it is possible to couple additional sensors via technical interfaces, that is, in particular, to integrate them into the sensor for velocity detection according to the invention, and to thereby collect supplemental environmental data (climate data such as temperature and relative humidity or roadway data, et cetera, for example) in a data logger and to incorporate it in the immediate or later analysis. The invention is recommended for use in the development of novel aerodynamic vehicles or parts thereof, in particular in order to enable validation of CFD simulations with real data.

Real, localized inflow conditions on moving objects can be detected by means of the apparatus according to the invention.

An additional use case is the enhancement of expertise of automated and autonomous driving systems with the detection of local flow conditions and flow relationships.

When calculating the various velocities in space from the sensor data recorded by the inertial navigation system, drift occurs as a result of an integration error inherent in the system which adds up over the duration of the measurement. This integration error can be compensated for by means of the wind data, which precisely determine and save wind velocity and wind direction at any given time. The individual sensor signals can be merged via various filters, such as complementary filters, Kalman filters, or the like. Integration errors can thereby be compensated for, in that quasi-stationary states of the individual sensors are used for calibration

If the sensor detects no oblique inflow, for example, that is, the main flow velocity is the correct velocity and the rotation rates are additionally constant, it is possible to calibrate the integrated travel velocity with the measured wind velocity.

The apparatus according to the invention has a compact housing in which all calculations are carried out internally, for which purpose a computing unit having an autonomous power supply is provided.

The subject matter of the invention is shown as an example in the drawings.

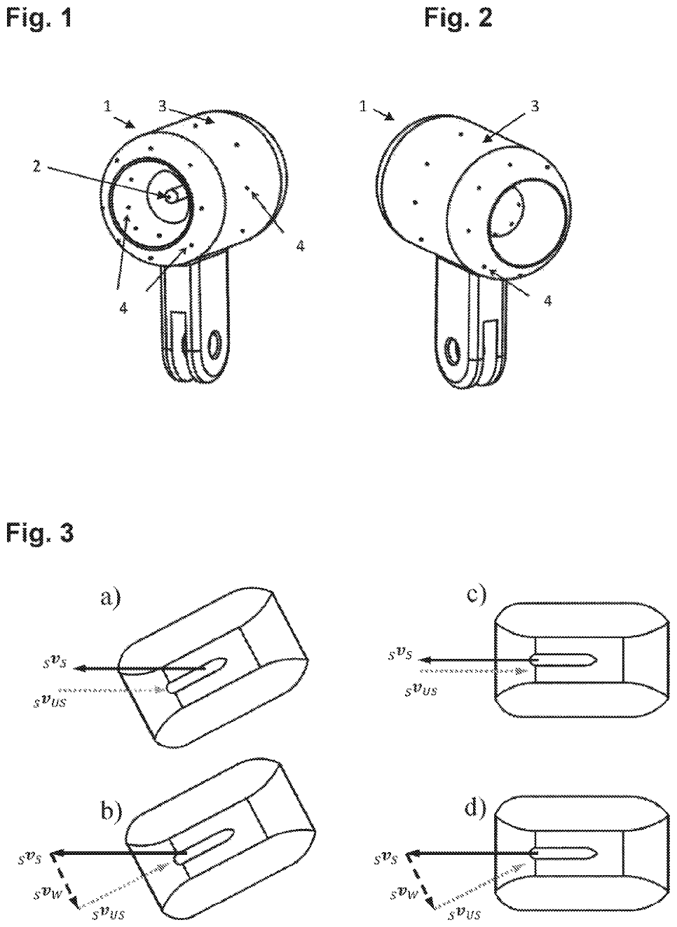

FIG. 1 shows an apparatus for velocity detection, in a view from an angle at the front,

FIG. 2 shows the apparatus in a view from an angle at the rear,

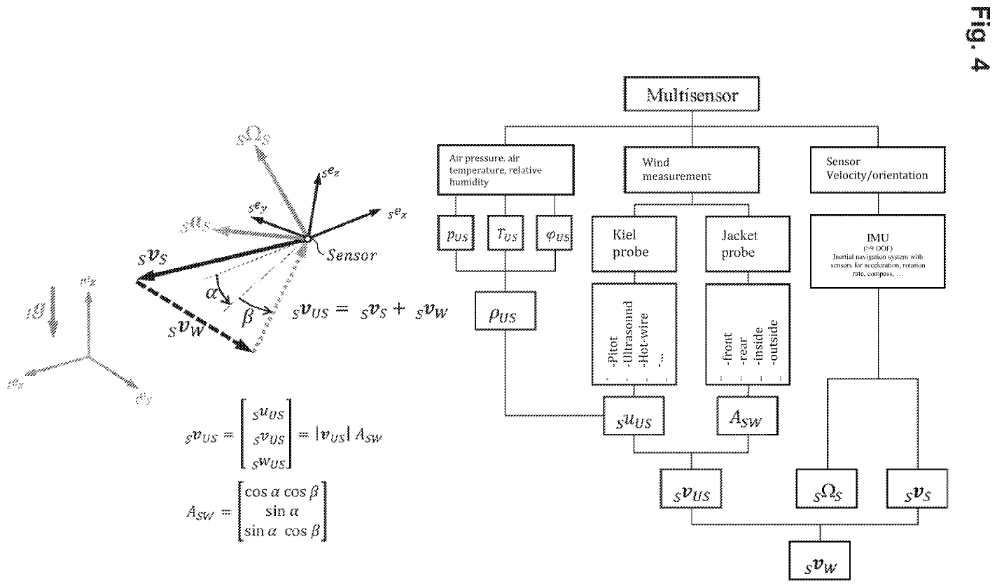

FIGS. 3a) to d) show the apparatus in a simplified section, in different motion and flow states, and

FIG. 4 shows a wiring diagram of an apparatus according to the invention.

The apparatus 1 for velocity detection comprises a Kiel probe 2 having a flow velocity probe which is encompassed by a shell element 3 forming a Venturi nozzle, wherein the shell element 3 is designed as a multi-hole dynamic pressure probe having holes 4 in the shell element 3, arranged distributed across the circumference of the shell.

The holes 4 in the shell element 3 arranged distributed across the circumference of the shell are preferably arranged uniformly distributed about a longitudinal axis of the flow velocity probe in a plane which is perpendicular to the longitudinal axis of the flow velocity probe.

At least two planes that are spaced apart are provided, in the direction of the longitudinal axis of the flow velocity probe, with holes arranged distributed across the circumference of the shell. One plane can also be sufficient, however

An inertial navigation system INS and a global positioning system GPS together with an analysis and communication unit are preferably arranged in the shell element. In addition, temperature (° C.) and/or relative humidity sensors (rF) are preferably provided in the shell element.

FIGS. 3a) to d) show examples of motion and flow states which can lead to incorrect measurement results in the case of individual sensors according to the state of the art.

In case a), the sensor velocity _{S}v_{S} and the wind vector _{S}v_{US} point in the opposite direction. The results are usable, but an orientation of the apparatus in the wind according to case c) would be better and more precise.

An identical global wind ₛv_{w} prevails in cases b) and d). In case b), the inflow direction of the wind vector ₛvᵤₛ is in the direction of the sensor axis. The global wind ₛv_{w} can be calculated using the direction known from the INS and/or GPS data, for example, and the sensor velocity value ₛvₛ.

In case d), the sensor velocity ₛvₛ is oriented in the direction of the sensor axis. The oblique inflow recorded by the multi-hole dynamic pressure probe allows the angle of inflow to be calculated and indicates the presence of global wind ₛv_{w}.

Both cases b) & d) deliver the same result.

The apparatus according to the invention comprises a wind sensor having a Kiel probe and multi-hole dynamic pressure probe, means for velocity and position detection and additional sensors for measuring air temperature, relative humidity and environmental pressure. All calculations are carried out by a microcontroller installed in the apparatus. The sensor output values are subsequently transmitted to a terminal device via a wired or wireless interface, such as WLAN, Bluetooth, ANT+ or the like. The sensor has a dedicated power supply. This comes either from an integrated battery having a charging circuit or comprises components of particularly low power consumption which draw the required power by means of power generation from the environment, such as from the wind.

1. An apparatus for velocity detection, said apparatus comprising:
a Kiel probe (2) having a flow velocity probe that is encompassed by a shell element forming a Venturi nozzle;
the shell element being configured as a multi-hole dynamic pressure probe, said shell element having holes in the shell element arranged distributed across a circumference of the shell element.

2. The apparatus according to claim 1, wherein dynamic pressure sensors are connected to the holes.

3. The apparatus according to claim 1, wherein the holes in the shell element arranged distributed across the circumference of the shell element are arranged uniformly distributed about a longitudinal axis of the flow velocity probe in a plane that is perpendicular to the longitudinal axis of the flow velocity probe.

4. The apparatus according to claim 2, wherein the holes are in a common plane and connect to the dynamic pressure sensors via dynamic pressure channels of equal length.

5. The apparatus according to claim 3, wherein, in a direction of a longitudinal axis of the flow velocity probe, the holes are located in at least two planes spaced apart from each other and wherein the holes in each of the planes are arranged distributed across the circumference of the shell element.

6. The apparatus according to claim 1, having an inertial navigation system.

7. The apparatus according to claim 1, having a global positioning system.

8. The apparatus according to claim 1, having a temperature sensor and/or a relative humidity sensor.

9. The apparatus according to claim 2, wherein the holes connect to the dynamic pressure sensors via dynamic pressure channels.

10. The apparatus according to claim 9, wherein the holes in the shell element arranged distributed across the circumference of the shell element are arranged uniformly distributed about a longitudinal axis of the flow velocity probe in a plane that is perpendicular to the longitudinal axis of the flow velocity probe.

11. The apparatus according to claim 2, wherein the holes in the shell element arranged distributed across the circumference of the shell element are arranged uniformly distributed about a longitudinal axis of the flow velocity probe in a plane that is perpendicular to the longitudinal axis of the flow velocity probe.

11. The apparatus according to claim 3, wherein the holes are in a common plane and the dynamic pressure sensors via dynamic pressure channels of equal length.

12. The apparatus according to claim 9, wherein the holes are in a common plane and the dynamic pressure channels are of equal length.

13. The apparatus according to claim 10, wherein the holes are in a common plane and the dynamic pressure channels are of equal length.

14. The apparatus according to claim 6, wherein the inertial navigation system is embedded in the shell element.

15. The apparatus according to claim 7, wherein the global positioning system is embedded in the shell element.

16. The apparatus according to claim 8, wherein the temperature sensor and/or the relative humidity sensor is embedded in the shell element.
